(19) United States
(12) Patent Application Publication
(10) Pub. No.: US 2024/0068606 A1
(43) Pub. Date: Feb. 29, 2024

(54) CONNECTION OF A PIPE-LIKE COMPONENT WITH A CONNECTING PART

(71) Applicant: Johannes Schäfer vorm. Stettiner Schraubenwerke GmbH & Co. KG, Hungen (DE)

(72) Inventors: Norbert FORRO, Reiskirchen (DE); Gerrit HEIDEROTH, Muenchhausen (DE)

(73) Assignee: Johannes Schäfer vorm. Stettiner Schraubenwerke GmbH & Co. KG, Hungen (DE)

(21) Appl. No.: 18/237,992

(22) Filed: Aug. 25, 2023

(30) Foreign Application Priority Data
Aug. 26, 2022 (DE) 10 2022 121 718.3

(51) Int. Cl. F16L 21/04; F16L 21/08

(52) U.S. Cl. CPC F16L 21/045; F16L 21/08

(57) ABSTRACT

In a method for the form-fit connection of a tubular component to a connecting part, the connecting part includes a through-hole with a connection end and a connecting end. A circumferential fastening groove is arranged on the inner surface of the connection end. One end of the pipe part is inserted into the through-hole of the connection end and secured against axial displacement. A tool is then used to exert a force acting in the longitudinal direction of the pipe part on the end of the pipe part present in the connecting part until the pipe part buckles out into the fastening groove, at least in some areas, and the pipe part and connecting part are permanently connected.

### CROSS REFERENCE TO RELATED APPLICATIOMS

Applicants claim priority under 35 U.S.C. § 119 of German Patent Application No. 10 2022 121 718.3 filed Aug. 26, 2022.

### FIELD OF THE INVENTION

The invention relates to a method for connecting a tubular component to a connecting part, a connection body and a system for carrying out the method.

### BACKGROUND OF THE INVENTION

For the connection of pipelines used within fluid-carrying systems, for example in commercial vehicle applications, screw or plug-in systems are usually used. Establishing the connection between the pipe and the connecting part, for example by screwing or soldering, is complex. When soldering, it is necessary to again apply a surface coating/corrosion protection afterwards. In addition, it may be necessary to subsequently check the connection for leaks in order to be able to establish the connection in a process-reliable manner.

A further possibility for connecting the connecting part and the pipeline is provided by a process in which a form-fit connection is established between the two components by forming the pipe. Components that have already been coated can also be used here.

Forming methods for pipes are sufficiently well known. For example, DE 100 40 595 A1 describes a method for forming an end region, in particular for cold-press forming a pipe end region, with a first force transmission element for clamping the tool and a second force transmission element for carrying out the forming being provided. According to DE 100 40 595 A1, a pressure medium is introduced into a pressure chamber extending between the first and second force transmission elements, the first force transmission element being actuated for clamping the workpiece and the second force transmission element being moved back into a starting position after forming using a pressure in the same pressure chamber.

U.S. Pat. No. 5,134,872 A describes a hydraulic tensioning device for expanding a pipe end. The device has a pipe receiving end into which the pipe to be expanded is inserted. A chuck contains a main piston that can be moved back and forth under fluid action in the direction of the tube receiving end. A ball fastened via a screw is located at one end of the main piston for expanding the tube. Inside a housing are the collets, which are driven by an actuator which in turn is bolted to a hollow actuating piston inside which the main piston slides.

A device for deforming a workpiece is known from EP 3 119 539 B1, with a forming assembly which can be actuated by the pressure of a fluid and with a clamping assembly which is arranged on a common longitudinal axis and can be actuated by the pressure of the fluid. The device comprises an exchangeable tool unit and a cylinder unit which is designed as a preassembled unit which can be handled separately from the exchangeable tool unit. The exchangeable tool unit is designed as a forming tool for the workpiece and comprises an upsetting head which on one side has a recess for forming a contour of the workpiece to be formed.

EP 1 311 358 B1 relates to a device for forming an end region of a workpiece, in particular for cold press forming a pipe end region.

For the known forming methods to be suitable for high-pressure applications, the connections must be permanently sealed, e.g., by means of an elastomer seal, and the existing sealing gap between the components must be as small as possible. Otherwise, a sealing gap that is too large can lead to permanent damage to the seal and thus to the connection. This is usually implemented in hydraulic applications by using support rings. However, this requires the introduction of an additional component.

The object of the invention is to provide a high-pressure-resistant connection between two components which can be established without further assembly components.

The object is achieved by the features of claim 1, claim 5 and claim 11. Preferred embodiments are described in the dependent claims.

According to the invention, the object is solved by providing a method for the form-fit connection of a pipe part, i.e., in particular a tubular component, to a connecting part, in which the connecting part comprises a through-hole with a connection end and a connecting end, wherein a circumferential fastening groove is present in the inner surface of the connection end, in which the pipe part is introduced at one end into the through-hole of the connection end and is secured against an axial displacement, in which a tool is used to exert a force acting in the longitudinal direction of the pipe part on the end of the tube part which is present in the connecting part until the pipe part is at least partially buckled out into the fastening groove and the pipe part and the connecting part are permanently connected.

The method achieves a permanent and form-fit connection of two components which is suitable for applications in the high-pressure range. An advantage of the invention is that a connection form is produced the system seal of which does not require any additional assembly components. Especially since in a preferred embodiment of the process, a sealing gap of substantially zero is achieved. Furthermore, this form of sealing is safe and reproducible due to the manufacturing process.

In one embodiment, it is provided that the force exerted with the tool in the longitudinal direction of the pipe part is acted on the end of the pipe part present in the connecting part until a sealing gap present between the outer surface of the pipe part and the inner surface of the connecting part is essentially zero. It has been shown that the force exerted by the tool on the pipe part causes the pipe part to fold open into the fastening groove and the material of the pipe part to come into contact with the wall of the through-hole of the connecting part, thereby reducing the sealing gap to substantially zero.

It has proved advantageous for the application of force if the force acting in the longitudinal direction is applied from the direction of the connecting part to the end face of the pipe part. This prevents damage to the pipe part and achieves targeted unfolding of the material of the pipe part in the connecting part.

In order to prevent the pipe part from unfolding outside of the connecting part, it is proposed that the pipe part be secured radially by clamping means that grip the lateral surface of the pipe part. These radially engaging clamping means can preferably be moved radially and wrap around the lateral surface of the pipe part.

The invention also relates to a connection body, comprising a connecting part and a pipe part, in which the connecting part comprises a through-hole with a connection end and a connecting end, wherein a circumferential fastening groove is arranged in the inner surface of the connection end, wherein the pipe part is at least partially bent out into the fastening groove. This means that the outer wall of the pipe part extends at least in regions into the fastening groove of the outer part. This results in a form-fit connection. It has been found that the connection is suitable in particular for applications in the low-pressure range, but also in the high-pressure range.

It has been found to be particularly advantageous if a sealing gap present between the outer surface of the pipe part and the inner surface of the connecting part is substantially zero. The connection provided in this way is connected without play.

In order to increase the area of application of the connection body and to improve the tightness of the connection, a sealing ring made of an elastic material may be present in the fastening groove. In a further embodiment, the sealing ring may be integrated in a bulge of the fastening groove. Due to the fact that there is a sealing ring in the fastening groove, assembly is simplified.

It can be provided that in the inner surface of the connection end there is a circumferential sealing ring groove with a sealing ring made of an elastic material arranged therein, the width of the sealing ring groove being smaller than that of the fastening groove. In this embodiment, the connecting part has another groove comprising a sealing ring. This ensures a high level of tightness even in high-pressure applications.

In one embodiment, a sealing ring groove may also be provided outside the connecting part, either in addition or as an alternative to the above-mentioned sealing ring groove in the connecting part. In this regard, it is provided that the outer surface of the pipe part has at least one circumferential sealing ring groove with a sealing ring made of an elastic material arranged therein.

Furthermore, the invention relates to a system for carrying out the method, comprising a first receptacle for a connecting part and a second receptacle for a pipe part arranged coaxially with respect to the first receptacle, such that one end of the pipe part can be introduced into the connecting part, with radially adjustable clamping means for radially securing of the pipe part, with means for axially securing the pipe part and with a tool which is axially adjustable relative to the pipe part and is configured such that, starting from the connecting part, a force can be exerted in the longitudinal direction of the pipe part on an end face of the end of the pipe part present in the connecting part, such that the pipe part buckles out into the fastening groove, at least in certain areas, and the pipe part and connecting part can be permanently connected The system can advantageously be in the form of a compact tool that allows a quick and easy connection of a connecting part and a pipe part. Moreover, the advantages and embodiments of the method can also be transferred to the system.

It has proven to be particularly advantageous if a sealing gap present between the outer surface of the pipe part and the inner surface of the connecting part is substantially zero. As a result, the connection provided can be used in a versatile manner.

### BRIEF DESCRIPTION OF THE DRAWING

The invention is discussed in more detail below with reference to exemplary embodiments of the invention, which are shown in the drawing. In the drawings:

FIG. 1 shows an exemplary connection body with a groove,

FIG. 2 shows an exemplary connection body with two grooves,

FIG. 3 shows a schematic implementation of the method,

FIG. 4 shows a detail view of a connecting part with a pipe part before and after the method,

FIG. 5 shows a detailed view of a tubular connection with a groove and a sealing ring arranged herein, and

FIG. 6 shows a further embodiment of a connection body with two grooves.

### DETAILED DESCRIPTION OF THE DRAWINGS

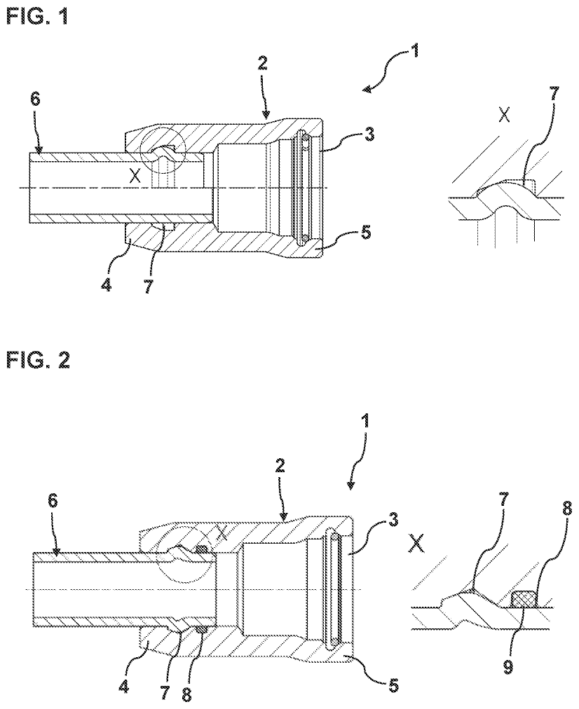

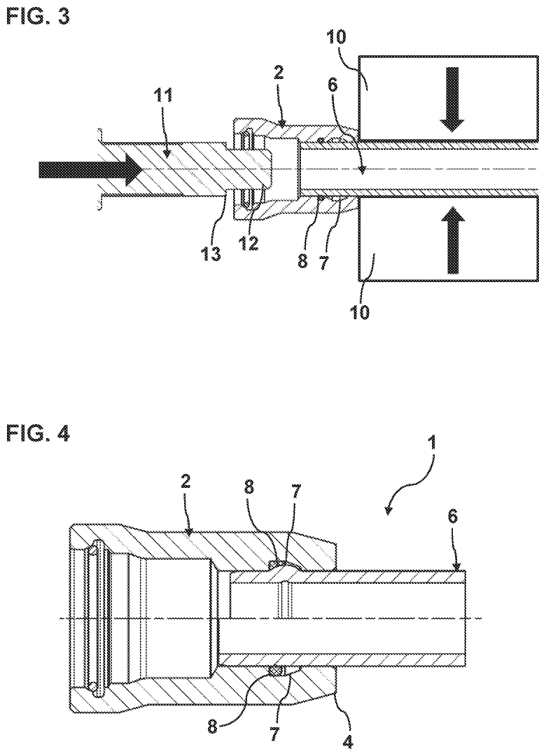

FIG. 1 shows an example of connection body with a groove and FIG. 2 shows a connection body with two grooves. The method is explained with reference to FIGS. 3 and 4, where the lower part of the figure illustrates the state before the method was carried out and the upper part illustrates the state after the method was carried out. The “X” and the circle indicate the enlarged detail shown on the right.

The connection body 1 has a connecting part 2. The connecting part 2 comprises a through-hole 3 with two end regions 4, 5, namely a connection end 4 and a connecting end 5. In this case, the connection end 4 is used to connect the connecting part 2 to a pipe part 6 which can be inserted into the through-hole 3 of the connecting part 2, in particular into the connection end 4. The outer diameter of the pipe part 6 and the inner diameter of the connection end 4 of the connecting part 2 are matched to one another so that the pipe part 6 can be introduced into the connecting part 2.

The connecting end 5 can be used to connect the connecting part 2 to a pipe or unit not shown. For this purpose, corresponding means can be present in the through-hole 3 in the connecting end 5, which, for example, establish a plug-in connection with the pipe. Examples of this are ring-shaped elevations, slopes, grooves or the like. The connecting part 2 can also have such means or threads on its surface, in particular its lateral surface, for establishing a connection with, for example, a pipe.

There is at least one circumferential groove in the connection end 4 adjacent to the opening of the through-hole 3, which is referred to as fastening groove 7 in the sense of the invention. The width of the fastening groove 7 can be adapted to the thickness of the pipe part 6, i.e., its wall thickness. The same applies to the depth of the fastening groove 7, which can also be varied according to the application and pipe part 6. The shape of the fastening groove 7 can be, for example, semicircular or the like. In the example shown, the fastening groove 7 is designed in the shape of an arrow with a flattened tip or conically tapered, with the two legs having different pitch angles.

In an embodiment of the connection body 1 shown in FIG. 2, there is a further groove adjacent to the fastening groove 7 in the direction of the connecting end 5, which is referred to as the sealing ring groove 8 in the sense of the invention. The width of the sealing ring groove 8 is smaller than that of the fastening groove 7. A sealing ring 9, for example an O-ring made of an elastomer, is accommodated in the sealing ring groove 8. The diameter of the sealing ring 9 is selected such that it is equal to or slightly larger than the depth of the sealing ring groove 8.

The pipe part 6 is moved over the connection end 4 in the direction of the connecting end 5 and beyond one or both grooves 7, 8 into the connecting part 2. The joining of the components 2, 6 is possible since there is advantageously a clearance fit in this state. In order to limit the movement of the pipe part 6, there can be a shoulder in the connecting part 2, for example, against which, at least in certain areas, the end face of the pipe part 6 abuts. Otherwise, the depth of insertion of the pipe part 6 can be determined empirically or can be defined by other means.

After the pipe part 6 has been inserted into the connecting part 2, it is secured on the rear side against axial displacement and radially by clamping jaws 10. The clamping jaws 10 are preferably dimensioned and aligned in such a way that the connecting part 2 also rests with the end face of the connection end 4 against the clamping jaws 10 and is thus also axially secured.

A tool 11 is then moved over the connecting end 5 into the connecting part 2. The tool 11 has a cylindrical pressure element 12, which has, at its free end which can be inserted into the pipe part 6 present in the connecting part 2, a smaller outer diameter than the region adjacent thereto. The resulting shoulder 13 existing between the two areas preferably rests with its end face against the end face of pipe part 6. The tool 11, or the pressure element 12 via the shoulder 13, exerts a force on the pipe part 6 in the longitudinal direction of the pipe part 6.

The introduction of this axial force exerted by the tool 11 on the pipe part 6 from the direction of the connecting part 2 produces a compression or radial unfolding of the material of the pipe part 6 in the direction of the connecting part 2. The unfolded material initially rests against the wall of the through-hole 3 of the connecting part 2, preferably reducing a sealing gap between the inner surface of the connecting part 2, or more precisely its connection end 4 and outer surface, or lateral surface of the pipe part 6, to a value of substantially zero. The force introduced in the axial direction further causes the wall of the pipe part 6 to buckle out into the available free space of the groove 7. Buckling of the pipe part 6 in a sealing ring groove 8 that may be present is hereby prevented since the width is relatively small and is below the groove width required for buckling. In particular, the width of the sealing ring groove 8 is smaller than the width of the fastening groove 7. The unfolded material of the pipe part 6 preferably rests against the wall of the fastening groove 7 and fills it substantially completely. The connection part 2 and the pipe part 6 are thus permanently connected.

It has been found that the sealing gap is substantially zero after the connection has been established, such that using the preferred embodiment of the method a connection body 1 can be provided which is predestined for use in the high-pressure range. The resulting forces are absorbed by the form-fit connection of the components, which is achieved by buckling the pipe part 6 into the fastening groove 7. The strain hardening carried out in this process can further increase the theoretical pull-out force of the pipe part 6 from the connecting part 2.

The method, or rather the connection established by it, is particularly advantageous with plug-in systems, by means of which the subsequent connection of two lines is also possible significantly more time-saving. Furthermore, lines can be connected even in very confined spaces, as no screwing step is necessary. Nevertheless, the form of the connection can also be used for any further adapter pieces, for example, also in combination with a conventional screwed pipe connection.

FIG. 4 shows a design in which the sealing ring 9 is inserted in the fastening groove 7 and there is no separate sealing ring groove 8. When the pipe part 6 is pushed into the fastening groove 7, the unfolded material of the pipe part 6 compresses the sealing ring 9, whereby the sealing ring 9, which consists in particular of an elastomer, is squeezed and changes its shape in the process. Here, too, a tight and durable connection is achieved.

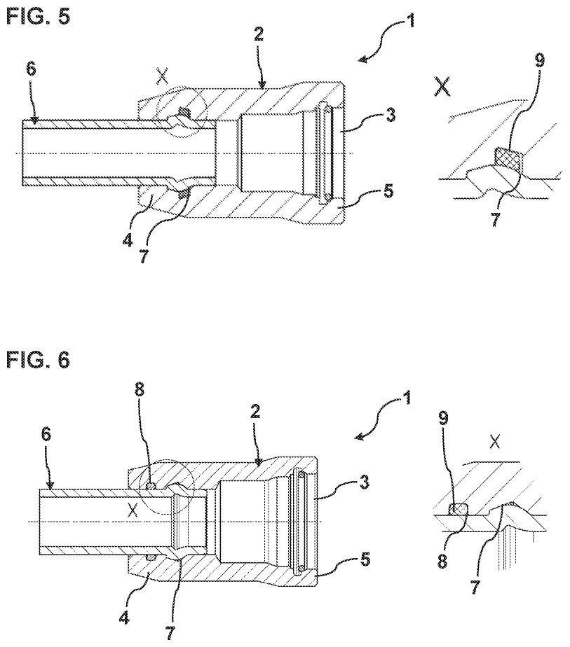

FIGS. 5 and 6 show variants of the connection body 1. In FIG. 5, there is only one fastening groove 7, with the fastening groove 7 substantially having a bulge, in particular a groove in the form of the sealing ring groove 8. The buckling of the pipe part 6 into the fastening groove 7 results in a contact with the sealing ring 9 present in the sealing ring groove 8 such that a seal and a form-fit connection between the pipe part 6 and the connecting part 2 is achieved.

Another embodiment is shown in FIG. 6. This embodiment, like FIG. 2, has two grooves 7, 8, but the arrangement of the grooves 7, 8 is inverted to the variant shown in FIG. 2. That is, the fastening groove 7 is arranged in the connection end 4 close to the pipe part 6 and the sealing ring groove 8 is located adjacent to the fastening groove 7 in the direction of the connecting end 5. The advantage of the variant is that the buckling of the pipe part 6 is protected from corrosion by the sealing ring 9, which is now on the outside.

1. A method for the form-fit connection of a pipe part (6) to a connecting part (2), in which the connecting part (2) comprises a through-hole (3) with a connection end (4) and a connecting end (5), wherein a circumferential fastening groove (7) is present in the inner surface of the connection end (4), in which the pipe part (6) is introduced at one end into the through-hole (3) of the connection end (4) and secured against an axial displacement, in which a tool (11) is used to exert a force acting in the longitudinal direction of the pipe part (6) on the end present in the connecting part (2) until the pipe part (6) is at least partially bent into the fastening groove (7) and the pipe part (6) and the connecting part (2) are permanently connected.

2. The method according to claim 1, wherein the force exerted with the tool (11) in the longitudinal direction of the pipe part (6) is acted on the end of the pipe part (6) present in the connecting part (2) until a sealing gap present between the outer surface of the pipe part (6) and the inner surface of the connecting part (2) is essentially zero.

3. The method according to claim 1, wherein the force acting in the longitudinal direction is applied from the direction of the connection part (2) to the end face of the pipe part (6).

4. The method according to claim 1, wherein the pipe part (6) is radially secured by clamping means (10) which grip the lateral surface of the pipe part (6).

5. A connection body, comprising a pipe part (6) and a connecting part (2), in which the connecting part (2) comprises a through-hole (3) with a connection end (4) and a connecting end (5), wherein a circumferential fastening groove (7) is arranged in the inner surface of the connection end (4), wherein the pipe part (6) is at least partially bent out into the fastening groove (7).

6. The connection body according to claim 5, wherein a sealing gap present between the outer surface of the pipe part (6) and the inner surface of the connecting part (2) is substantially zero.

7. The connection body according to claim 5 or 6, wherein a sealing ring (9) made of an elastic material is present in the fastening groove (7).

8. The connection body according to claim 7, wherein the fastening groove (7) has a bulge in which a sealing ring (9) is introduced.

9. The connection body according to claim 5, wherein the inner surface of the connection end (4) has a circumferential sealing ring groove (8) with a sealing ring (9) made of an elastic material arranged therein, the width of the sealing ring groove (8) being less than that of the fastening groove (7).

10. The connection body according to claim 5, wherein the outer surface of the pipe part (6) has at least one circumferential sealing ring groove (8) with a sealing ring (9) made of an elastic material arranged therein.

11. A system for carrying out the method according to claim 1, comprising a first receptacle for a connecting part (2) and a second receptacle for a pipe part (6) arranged coaxially with respect to the first receptacle, such that one end of the pipe part (6) can be introduced into the connecting part (2), with radially adjustable clamping means (10) for radially securing the pipe part (6), with means for axially securing the pipe part (6) and with a tool (11) which is axially adjustable relative to the pipe part (6) and is configured such that, starting from the connecting part (2), a force can be exerted in the longitudinal direction of the pipe part (6) on an end face of the end of the pipe part (6) present in the connecting part (2), such that the pipe part (6) buckles out into the fastening groove (7), at least in certain areas, and the pipe part (6) and connecting part (2) can be permanently connected

12. The system according to claim 11, wherein the force is exerted by the tool (11) onto the pipe part (6) until a sealing gap present between the outer surface of the pipe part (6) and the inner surface of the connecting part (2) is substantially zero.
